(19) United States
(12) Patent Application Publication
(10) Pub. No.: US 2024/0428075 A1
(43) Pub. Date: Dec. 26, 2024

(54) RANKING ITEMS FOR PRESENTATION IN A USER INTERFACE

(71) Applicant: Roblox Corporation, San Mateo, CA (US)

(72) Inventors: Xiaohong GONG, Sunnyvale, CA (US); Frank ONG, San Mateo, CA (US); Zhen ZHANG, San Mateo, CA (US)

(73) Assignee: Roblox Corporation, San Mateo, CA (US)

(21) Appl. No.: 18/213,307

(22) Filed: Jun. 23, 2023

(51) Int. Cl. G06N 3/084; G06Q 30/0601

(52) U.S. Cl. CPC G06N 3/084; G06Q 30/0631

(57) ABSTRACT

A computer-implemented method includes receiving training data that includes groups of items and a respective user associated with each group, where each group includes a first item selected by the associated user and one or more second items rejected by the associated user from a user interface in which the first item and the one or more second items are presented together in ranked order. The method includes, for each group in the group of items: generating feature embeddings, calculating a pointwise loss for each item in the group based on the feature embeddings, calculating a comparator loss for a set that includes the first item and at least one of the one or more second items, and adjusting one or more parameters of the machine learning model based on the pointwise loss and the comparator loss. The method further includes obtaining a trained machine learning model.

### BACKGROUND

Recommendation systems are commonly utilized to suggest items that a user may be interested in. For example, a recommendation system may rank items in an online store based on a likelihood of being purchased by the user. The ranked items may be displayed in a user interface, e.g., a storefront user interface, or other suitable user interface. Machine learning techniques may be used to identify items of interest and/or to rank the identified items.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Embodiments relate generally to a method to train and use a machine-learning model to recommend virtual experiences to a user. The method includes receiving training data that includes groups of virtual experiences and a respective user associated with each group, wherein each group includes a first virtual experience selected by the associated user and one or more second virtual experiences rejected by the associated user from a user interface in which the first virtual experience and the one or more second virtual experiences are presented together in a ranked order and wherein the virtual experiences are associated with item features and the associated user is associated with user features. The method further includes, for each group in the groups of virtual experiences: generating feature embeddings based on the item features of the virtual experiences in the group and the user features of the associated user; calculating, from a machine-learning model, a pointwise loss for each virtual experience in the group based on the feature embeddings; calculating, from the machine-learning model, a comparator loss for a set that includes the first virtual experience and at least one of the one or more second virtual experiences; and adjusting one or more parameters of the machine-learning model based on the pointwise loss and the comparator loss. The method further includes obtaining a trained machine-learning model by iteratively performing the generating, calculating the pointwise loss, calculating the comparator loss, and adjusting the one or more parameters until a stopping criterion is met.

In some embodiments, adjusting the one or more parameters of the machine-learning model based on the pointwise loss and the comparator loss comprises performing backpropagation using a loss value that is a linear weighted combination of the pointwise loss and the comparator loss. In some embodiments, the pointwise loss for the virtual experience is based on an output probability predicted by the machine-learning model. In some embodiments, the comparator loss for each group is a sum of a respective pairwise loss for each comparison of the first virtual experience and a particular one of the one or more second virtual experiences. In some embodiments, the respective pairwise loss includes a sum of a difference in output probabilities associated with the first virtual experience and the particular one of the one or more second virtual experiences. In some embodiments, the respective pairwise loss further includes a hyperparameter that defines a minimum distance.

In some embodiments, the method further includes obtaining a sequence of user features, wherein the sequence is based on user activity on a virtual experience platform that hosts the virtual experiences and performing attention modeling based on the sequence of user features, wherein the feature embeddings are based on the attention modeling. In some embodiments, the user activity includes selecting particular virtual experiences. In some embodiments, the stopping criterion includes one or more of: a computational budget for training being exhausted or a change in parameter values of at least one of the one or more parameters between successive iterations falling below a threshold. In some embodiments, the method further includes receiving candidate user features for a candidate user and candidate item features for a plurality of candidate virtual experiences; outputting, by the trained machine-learning model, a rank for each of the candidate virtual experiences; and causing the candidate virtual experiences to be displayed in a second user interface in order of the rank.

According to one aspect, a non-transitory computer-readable medium includes instructions that, when executed by one or more processors, cause the one or more processors to perform operations. The operations may include receiving training data that includes groups of virtual experiences and a respective user associated with each group, wherein each group includes a first virtual experience selected by the associated user and one or more second virtual experiences rejected by the associated user from a user interface in which the first virtual experience and the one or more second virtual experiences are presented together in a ranked order and wherein the virtual experiences are associated with item features and the associated user is associated with user features. The operations may further include for each group in the groups of virtual experiences: generating feature embeddings based on the item features of the virtual experiences in the group and the user features of the associated user; calculating, from a machine-learning model, a pointwise loss for each virtual experience in the group based on the feature embeddings; calculating, from the machine-learning model, a comparator loss for a set that includes the first virtual experience and at least one of the one or more second virtual experiences; and adjusting one or more parameters of the machine-learning model based on the pointwise loss and the comparator loss. The operations may further include obtaining a trained machine-learning model by iteratively performing the generating, calculating the pointwise loss, calculating the comparator loss, and adjusting the one or more parameters until a stopping criterion is met.

In some embodiments, adjusting the one or more parameters of the machine-learning model based on the pointwise loss and the comparator loss comprises performing backpropagation using a loss value that is a linear weighted combination of the pointwise loss and the comparator loss. In some embodiments, the pointwise loss for the virtual experience is based on an output probability predicted by the machine-learning model. In some embodiments, the comparator loss for each group is a sum of a respective pairwise loss for each comparison of the first virtual experience and a particular one of the one or more second virtual experiences. In some embodiments, the respective pairwise loss includes a sum of a difference in output probabilities associated with the first virtual experience and the particular one of the one or more second virtual experiences.

According to one aspect, a device includes a processor and a memory coupled to the processor, with instructions stored thereon that, when executed by the processor, cause the processor to perform operations. The operations may include receiving training data that includes groups of virtual experiences and a respective user associated with each group, wherein each group includes a first virtual experience selected by the associated user and one or more second virtual experiences rejected by the associated user from a user interface in which the first virtual experience and the one or more second virtual experiences are presented together in a ranked order and wherein the virtual experiences are associated with item features and the associated user is associated with user features. The operations may further include for each group in the groups of virtual experiences: generating feature embeddings based on the item features of the virtual experiences in the group and the user features of the associated user; calculating, from a machine-learning model, a pointwise loss for each virtual experience in the group based on the feature embeddings; calculating, from the machine-learning model, a comparator loss for a set that includes the first virtual experience and at least one of the one or more second virtual experiences; and adjusting one or more parameters of the machine-learning model based on the pointwise loss and the comparator loss. The operations may further include obtaining a trained machine-learning model by iteratively performing the generating, calculating the pointwise loss, calculating the comparator loss, and adjusting the one or more parameters until a stopping criterion is met.

In some embodiments, adjusting the one or more parameters of the machine-learning model based on the pointwise loss and the comparator loss comprises performing backpropagation using a loss value that is a linear weighted combination of the pointwise loss and the comparator loss. In some embodiments, the pointwise loss for the virtual experience is based on an output probability predicted by the machine-learning model. In some embodiments, the comparator loss for each group is a sum of a respective pairwise loss for each comparison of the first virtual experience and a particular one of the one or more second virtual experiences. In some embodiments, the respective pairwise loss includes a sum of a difference in output probabilities associated with the first virtual experience and the particular one of the one or more second virtual experiences.

### BRIEF DESCRIPTION OF THE DRAWINGS

FIG. 1 is a block diagram of an example network environment to train a machine-learning model to recommend virtual experiences to users, according to some embodiments described herein.

FIG. 2 is a block diagram of an example computing device to train a machine-learning model to recommend virtual experiences to users, according to some embodiments described herein.

FIG. 3 is a block diagram of an example process to recommend items to a user, according to some embodiments described herein.

FIGS. 4A-4B are example illustrations of training data pair construction with a positive example and a negative example, according to some embodiments described herein.

FIGS. 5A-5B are example illustrations of training data construction with multiple negative examples, according to some embodiments described herein.

FIG. 6 is a block diagram of an example architecture of the candidate ranker module, according to some embodiments described herein.

FIG. 7 is a block diagram that illustrates how the first branch and the second branch in the example architecture of FIG. 6 compare positive items and negative items for loss functions, according to some embodiments described herein.

FIG. 8 is a flow diagram of an example method to train a machine-learning model to recommend items, according to some embodiments described herein.

FIG. 9 is a flow diagram of an example method to train a machine-learning model to recommend virtual experiences, according to some embodiments described herein.

FIG. 10 is a flow diagram of an example method to provide candidate virtual experiences to a user, according to some embodiments described herein.

### DETAILED DESCRIPTION

In many online contexts, identifying items that are likely to be of interest to a user and displaying them in a user interface is an important task. Item identification and ranking can be performed using any suitable technique, such as recommendation algorithms, machine learning, etc. With user permission, personalization of recommendation is performed by identifying and/or ranking items based on user data (e.g., online activity in a virtual environment platform that hosts multiple virtual experiences, social media activity, online shopping activity, etc.)

While many recommendation algorithms and machine learning techniques can identify items likely of interest to a user, ranking such items is important when displaying items in a user interface. For example, a user interface for a virtual environment may have a limited amount of space (e.g., slots that can display 3 items, 5 items, etc.) within which the identified items are to be displayed. If multiple recommendation techniques (also referred to as candidate generators) are used, different sets of items may be identified by each technique being likely of interest to the user. Even if the sets are identical or overlapping, items may be ranked in a different order. In such a situation, selecting items for display in a user interface is difficult.

Machine-learning based ranking (or reranking) can be performed to rank items for display in a user interface. However, traditional rerankers provide pointwise ranking for each item from the identified set obtained from one or more candidate generators, since reranking machine learning models are trained to output a respective rank for items in the identified set, irrespective of other items that may be displayed in the user interface along with any given item. However, such rerankers may not provide sufficiently high quality ranking when a user interface includes multiple displayed items, since the context of other items displayed (co-impressed) with an item is not incorporated into the reranker.

The methods, systems, and computer-readable media described herein address these problems by training a machine learning based reranker (reranker model) to rank items (e.g., virtual experiences on a virtual experience platform) based on prior user activity with respect to the items. The training data used to train the reranker model can include information that indicates items that were selected by a user (e.g., from a set of items displayed in a user interface) and additionally, information that indicates c-impressed items (items that were displayed in the user interface together with a user-selected item, but were not selected by the user). A pointwise loss and a comparator loss (which may be a combination of pairwise losses) is determined based on ranks output by a reranker model based on each set of items in the training data (that include one or more user-selected items, and one or more items that were co-impressed but not selected). The reranker model is trained to minimize the pointwise loss for each item and the comparator loss. The training may include adjusting one or more model parameters (e.g., when the reranker model is implemented as a neural network, the weight of one or more nodes of the neural network). The incorporation of context (co-impressed items and which items were selected) in the training data and the loss function used for model training enables obtaining a trained reranker model that has higher accuracy than traditional rerankers that do not incorporate such context. Examples of model architectures for a reranker model and loss functions (pointwise loss, pairwise loss, comparator loss) are described.

By training a reranker model independent of the candidate generators, the trained model can be utilized with any type and combination of candidate generators. Updates to candidate generators or use of new candidate generators do not require the reranker model to be trained. Thus, separation of the candidate generators from the reranker model provides a technical benefit by reducing the computational load to train the reranker model.

Further, the reranker model can be updated periodically when new training data is available. Such retraining can improve the reranker model over time and can be performed independently of the candidate generators.

The reranker model provides additional technical benefits. Items that are displayed in a ranked order in a user interface (e.g., top 3 items, top 5 items) have a high likelihood of user selection over lower-ranked items (that may be accessible via additional user actions such as scrolling). In this case, by providing improved ranks (that take into account the user interface context), the ranker model can save computational cost to render and/or display additional user interfaces in response to scrolling or other user input.

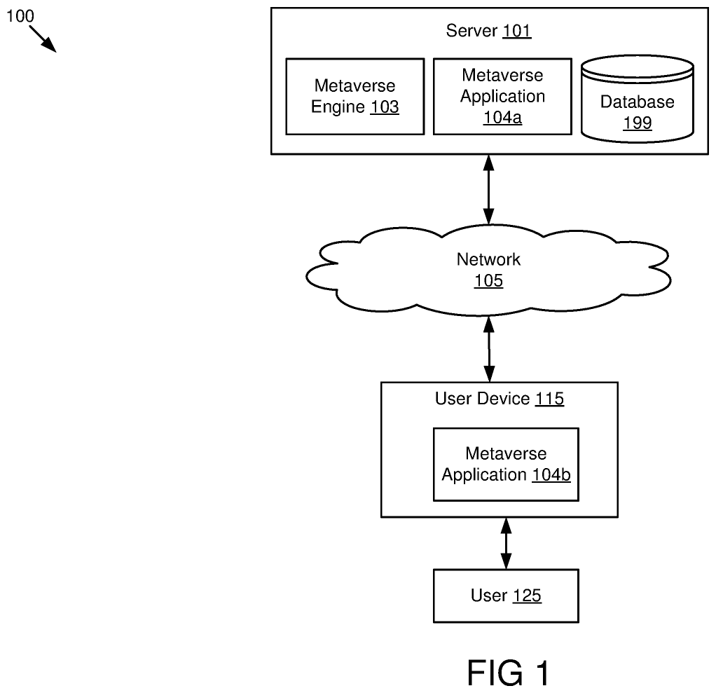

FIG. 1 illustrates a block diagram of an example environment 100 to train a machine-learning model to recommend a ranked set of virtual experiences to users. In some embodiments, the environment 100 includes a server 101, a user device 115, and a network 105. Users 125 may be associated with the user device 115. In some embodiments, the environment 100 may include other servers or devices not shown in FIG. 1. For example, the server 101 may be multiple servers 101 and the user device 115 may be multiple user devices 115a, 115n.

The server 101 includes one or more servers that each include a processor, a memory, and network communication hardware. In some embodiments, the server 101 is a hardware server. The server 101 is communicatively coupled to the network 105. In some embodiments, the server 101 sends and receives data to and from the user device 115. The server 101 may include a metaverse engine 103, a metaverse application 104a, and a database 199. In FIG. 1 and the remaining figures, a letter after a reference number, e.g., “104a,” represents a reference to the element having that particular reference number. A reference number in the text without a following letter, e.g., “104,” represents a general reference to embodiments of the element bearing that reference number.

In some embodiments, the metaverse engine 103 includes code and routines operable to receive communications between two or more users in a virtual metaverse, for example, at a same location in the metaverse, within a same metaverse experience, or between friends within a metaverse application. The users interact within the metaverse across different demographics (e.g., different ages, regions, languages, etc.).

In some embodiments, the metaverse application 104a includes code and routines operable to receive training data that includes groups of virtual experiences and a respective user associated with each group. Each group includes a first virtual experience selected by the associated user and one or more second virtual experiences rejected by the associated user from a user interface in which the first virtual experience and the one or more second virtual experiences are presented together in ranked order. The virtual experiences are associated with item features and the associated user is associated with user features.

For each group in the groups of virtual experiences, the metaverse application 104a generates feature embeddings based on the item features of the virtual experiences in the group and the user features of the associated user. The metaverse application 104a calculates, from a machine-learning model, a pointwise loss for each virtual experience in the group based on the feature embeddings. The machine-learning model calculates a comparator loss for a set that includes the first virtual experience and at least one of the one or more second virtual experiences. The metaverse application 104a adjusts one or more parameters of the machine-learning model based on the pointwise loss and the comparator loss.

The metaverse application 104a obtains a trained machine-learning model by iteratively performing the generating, calculating the pointwise loss, calculating the comparator loss, and adjusting the one or more parameters until a stopping criterion is met.

In some embodiments, the metaverse application 104a is implemented using hardware including a central processing unit (CPU), a field-programmable gate array (FPGA), an application-specific integrated circuit (ASIC), any other type of processor, or a combination thereof. In some embodiments, the metaverse engine 103 is implemented using a combination of hardware and software.

The database 199 may be a non-transitory computer readable memory (e.g., random access memory), a cache, a drive (e.g., a hard drive), a flash drive, a database system, or another type of component or device capable of storing data. The database 199 may also include multiple storage components (e.g., multiple drives or multiple databases) that may also span multiple computing devices (e.g., multiple server computers). The database 199 may store data associated with the metaverse engine 103 and the metaverse application 104a, such as training data sets for the trained machine-learning model, user actions and user features associated with each user 125, item features associated with each virtual experience, sequence user features that describe a history of user behavior, etc.

The user device 115 may be a computing device that includes a memory and a hardware processor. For example, the user device 115 may include a mobile device, a tablet computer, a laptop, a desktop computer, a mobile telephone, a wearable device, a head-mounted display, a mobile email device, a portable game player, a portable music player, or another electronic device capable of accessing a network 105. Although one user device 115 is illustrated in FIG. 1, one or more user devices 115 may be part of the environment 100.

The user device 115 includes metaverse application 104b. In some embodiments, the metaverse application 104b receives one or more recommended virtual experiences from the metaverse application 104a on the server 101. The metaverse application 104b generates a user interface that displays a ranked set of recommended virtual experiences to the user 125.

In some embodiments, and with user consent, the user's response to the virtual experiences may be used as training data. For example, the user interface may display a first virtual experience that is selected by the user 125 and one or more second virtual experiences that are not selected by the user. The training data may include item features associated with the first virtual experience, the one or more second virtual experiences, a ranked order if the virtual experiences were displayed in a ranked order, and user features.

In the illustrated embodiment, the entities of the environment 100 are communicatively coupled via a network 105. The network 105 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a Long Term Evolution (LTE) network), routers, hubs, switches, server computers, or a combination thereof. Although FIG. 1 illustrates one network 105 coupled to the server 101 and the user devices 115, in practice one or more networks 105 may be coupled to these entities.

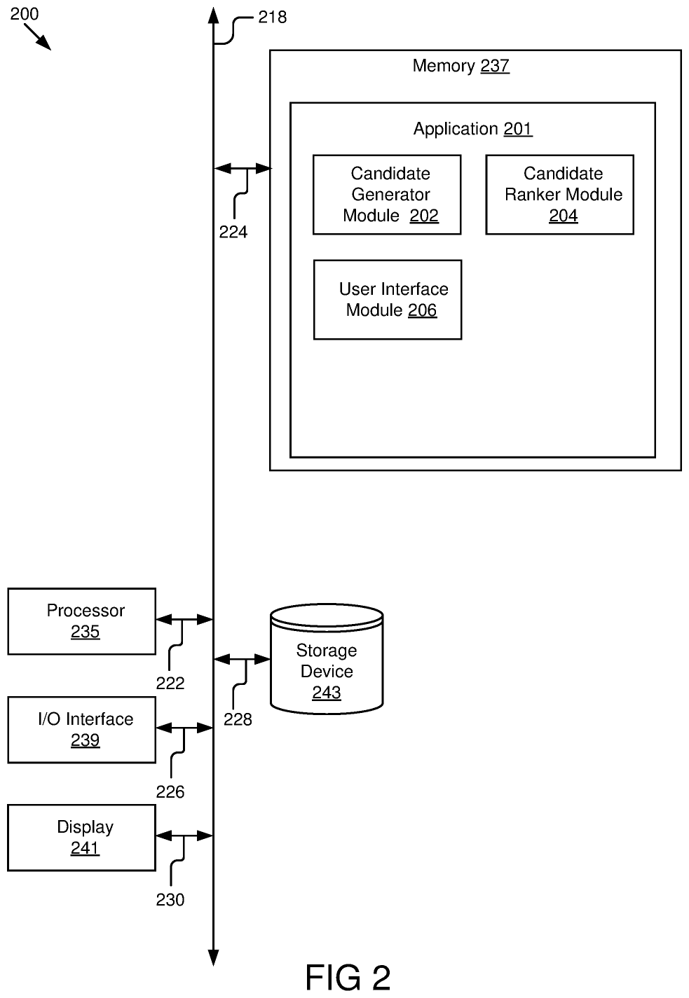

FIG. 2 is a block diagram of an example computing device 200 that may be used to implement one or more features described herein. Computing device 200 can be any suitable computer system, server, or other electronic or hardware device. In some embodiments, computing device 200 is the server 101. In some embodiments, the computing device 200 is the user device 115.

In some embodiments, computing device 200 includes a processor 235, a memory 237, an Input/Output (I/O) interface 239, a display 241, and a storage device 243. Depending on whether the computing device 200 is the server 101 or the user device 115, some components of the computing device 200 may not be present. For example, in instances where the computing device 200 is the server 101, the computing device may not include the display 241. In some embodiments, the computing device 200 includes additional components not illustrated in FIG. 2.

The processor 235 may be coupled to a bus 218 via signal line 222, the memory 237 may be coupled to the bus 218 via signal line 224, the I/O interface 239 may be coupled to the bus 218 via signal line 226, the display 241 may be coupled to the bus 218 via signal line 230, and the storage device 243 may be coupled to the bus 218 via signal line 228.

The processor 235 includes an arithmetic logic unit, a microprocessor, a general-purpose controller, or some other processor array to perform computations and provide instructions to a display device. Processor 235 processes data and may include various computing architectures including a complex instruction set computer (CISC) architecture, a reduced instruction set computer (RISC) architecture, or an architecture implementing a combination of instruction sets. Although FIG. 2 illustrates a single processor 235, multiple processors 235 may be included. In different embodiments, processor 235 may be a single-core processor or a multicore processor. Other processors (e.g., graphics processing units), operating systems, sensors, displays, and/or physical configurations may be part of the computing device 200.

The memory 237 stores instructions that may be executed by the processor 235 and/or data. The instructions may include code and/or routines for performing the techniques described herein. The memory 237 may be a dynamic random access memory (DRAM) device, a static RAM, or some other memory device. In some embodiments, the memory 237 also includes a non-volatile memory, such as a static random access memory (SRAM) device or flash memory, or similar permanent storage device and media including a hard disk drive, a compact disc read only memory (CD-ROM) device, a DVD-ROM device, a DVD-RAM device, a DVD-RW device, a flash memory device, or some other mass storage device for storing information on a more permanent basis. The memory 237 includes code and routines operable to execute the application 201, which is described in greater detail below.

I/O interface 239 can provide functions to enable interfacing the computing device 200 with other systems and devices. Interfaced devices can be included as part of the computing device 200 or can be separate and communicate with the computing device 200. For example, network communication devices, storage devices (e.g., memory 237 and/or storage device 243), and input/output devices can communicate via I/O interface 239. In another example, the I/O interface 239 can receive data from user device 115 and deliver the data to the application 201 and components of the application 201, such as the candidate generator module 202. In some embodiments, the I/O interface 239 can connect to interface devices such as input devices (keyboard, pointing device, touchscreen, microphone, sensors, etc.) and/or output devices (display devices, speakers, monitors, etc.).

Some examples of interfaced devices that can connect to I/O interface 239 can include a display 241 that can be used to display content, e.g., images, video, and/or a user interface of an output application as described herein, and to receive touch (or gesture) input from a user. Display 241 can include any suitable display device such as a liquid crystal display (LCD), light emitting diode (LED), or plasma display screen, cathode ray tube (CRT), television, monitor, touchscreen, three-dimensional display screen, or other visual display device.

The storage device 243 stores data related to the application 201. For example, the storage device 243 may store as training data sets for the trained machine-learning model, user actions and user features associated with each user 125, item features associated with each virtual experience, sequence user features that describe a history of user behavior, etc. In embodiments where the computing device 200 is the server 101, the storage device 243 is the same as the database 199 in FIG. 1.

FIG. 2 illustrates a computing device 200 that executes an example application 201 that includes a candidate generator module 202, a candidate ranker module 204, and a user interface module 206.

In some embodiments, the candidate generator module 202 determines candidate items for a user. The items may be virtual experiences where a virtual experience is an artificial environment that is provided by a computer where the user's actions partially determine what happens in the environment. For example, the virtual experience may be a game that a user plays, a virtual concert or meeting that a user attends, etc. The items may be other experiences provided by a computer, such as movies, songs, or other media items; social network content (e.g., items in a social network feed); articles; a software app in an application store; a set of directions in a digital map; items available for purchase via an online store, etc. Although the application 201 is described with reference to virtual experiences, the application 201 may also train a machine-learning model to output a ranked order of items for other purposes, such as items that are music, movies, friends in a social network, etc.

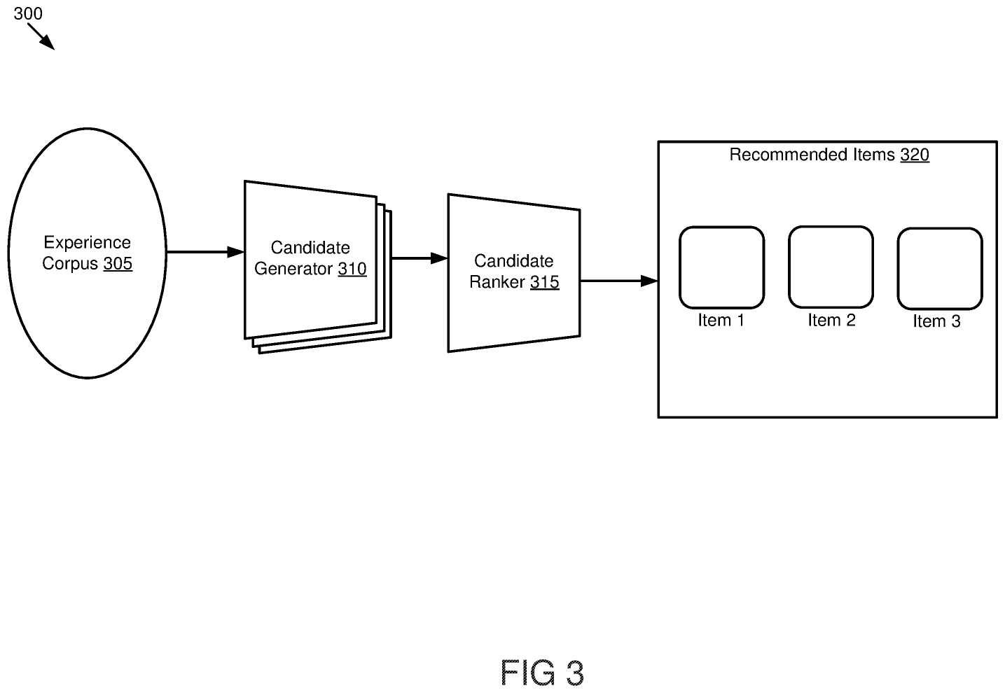

In some embodiments, the process for recommending virtual experiences is broken into four stages. FIG. 3 is a block diagram 300 of an example process to recommend items to a user. In this example, the process is divided into an experience corpus 305, candidate generators 310, one or more candidate rankers 315, and recommended items 320. The experience corpus 305 includes all the items available to a user. The experience corpus 305 may include hundreds of thousands or even millions of items. In some embodiments, the multiple candidate generators 310 include a different module for each type of graph discussed in greater detail below. The one or more candidate generators 310 retrieve the top K items from the experience corpus 305. The candidate ranker 315 ranks the top K items based on the user's own interests, history, and context (obtained with user permission), and outputs the top N items. The top N items are then displayed to the user, for example, by transmitting graphical data for displaying a user interface that includes the top N items from the server 101 to a user device 115.

In some embodiments, both the candidate generator 310 and the candidate ranker 315 include machine-learning models (e.g., deep neural network (DNN) models) that include layers that identify increasingly more high-level features and patterns about the different embeddings where the output of one layer serves as input to a subsequent layer. Training DNNs may involve using large sets of labeled training data due to the large number of parameters that are part of the DNNs. Specifically, the DNNs may generate embeddings that are improved by larger training data sets.

A user may be described by user features and an item may be described by item features. User features may include user-permitted features such as, for example, demographic information for a user (location, gender, age, etc.), user interaction history (e.g., duration of interaction with a virtual experience, clicks during the interaction, money spent during the interaction, etc.), context features (e.g., device identifier, an internet protocol (IP) address for the client device, country), user identifiers (ID) for people that the user plays with, etc. In some embodiments, the user features may be sequential in time (i.e., also known as sequence user features), such as clicks, purchases, activity within a metaverse application, or the user features may not be sequential, such as demographic information, IP address, location, device ID, etc.

The item features may include a universe ID (i.e., the unique identifier for a virtual experience, such as a game), the daily active users (DAU) (i.e., the number of active users that interact with the virtual experience in the past predetermined number of days), an identification of a developer of the virtual experience, how many developer items are in the virtual experience, the release date for the virtual experience, etc. Item features may be different for different types of items; however, item features characterize the item by intrinsic features (e.g., movies are characterized by genre, actors, duration) and user-generated features (e.g., movies have popularity, user rankings, etc.).

The candidate generator 310 and the candidate ranker 315 are trained with user features and item features. The candidate generator 310 may be a model that generates user embeddings and item embeddings and compares the user embeddings and item embeddings to each other to identify the candidate items. As a result, the training data includes original training examples corresponding to a set of items, where individual training examples comprise user features and item features. The candidate ranker 315 may be trained with different user features and item features than the candidate generator 310. For example, both sets of training data are labeled with different items because the goals for training the candidate generator 310 and the candidate ranker 315 are different. In some embodiments, the candidate ranker 315 is additionally trained with sequence user features. Using a separate candidate generator 310 and candidate ranker 315 may advantageously allow the candidate ranker 315 to rank items generated by any candidate generator without regard to the mechanism of the candidate generator, accuracy, etc. In addition, the candidate ranker 315 may rank items from multiple candidate generators, where the candidate generators may individually identify items of interest without necessarily having to rank the items.

In some embodiments, the candidate generator module 202 trains a machine-learning model to identify candidate virtual experiences and uses the trained machine-learning model to identify candidate virtual experiences at runtime (e.g., in response to a user request, to render a storefront user experience, etc. The candidate generator module 202 receives training data that includes pairs of users and virtual experiences, where each user of a pair is associated with user features and each virtual experience of the pair is associated with item features. Examples of user features may include a user interacting with the virtual experience by playing a game with other users, purchasing items in a game, commenting on a post made by a user in the virtual experience, watching/playing for a particular duration, playing at a particular time, etc.

Once the machine-learning model for the candidate generator module 202 is trained, the machine-learning model receives user features associated with a user as input. The machine-learning model may generate a user embedding based on the user features and perform a dot product between the vectors for the user embeddings and the vectors for the already generated item embeddings. The machine-learning model may perform an approximate neighbor search to determine the candidate virtual experiences that best correspond to the user features. In some embodiments where the candidate generator module 202 includes multiple candidate generators, the candidate generator module 202 may select a top N number of candidate virtual experiences based on the results from the multiple candidate generators. The candidate generator module 202 may provide a query to each of the candidate generators, receive candidate virtual experiences, and provide the top N number of virtual experiences to the candidate ranker module 204 for ranking.

The candidate ranker module 204 receives K top candidate virtual experiences from the candidate generator module 202, re-ranks the top K candidate virtual experiences based on user features associated with a particular user, and outputs the top N virtual experiences, which are provided to the particular user.

The candidate ranker module 204 uses a machine-learning model to rank the candidate virtual experiences. In some embodiments, the candidate generator module 202 trains a first machine-learning model to generate candidate virtual experiences and the candidate ranker module 204 trains a second machine-learning model to rank a subset of the candidate virtual experiences that are identified by the candidate generator module 202. The second machine-learning model is hereafter referred to as the machine-learning model in association with the candidate ranker module 204 for ease of explanation.

The machine-learning model is trained to rank the candidate virtual experiences. In some embodiments, the machine-learning model is optimized to rank the candidate virtual experiences based on a particular attribute, such as a prediction of which virtual experience will be associated with a longest interaction time, a likelihood of purchase in association with the virtual experience, the top virtual experiences based on the current time of day, etc.

The candidate ranker module 204 trains the machine-learning model using a comparison of a positive example and one or more negative examples that have been provided together in a user interface (i.e., the positive example and the one or more negative examples are co-impressed together). When a user views two or more virtual experiences together (e.g., in a storefront user interface), the virtual experience that the user selects is preferred by the user over the virtual experience(s) that the user did not select. By considering each virtual experience with a positive label (“selected by user”) in the context of a co-impressed virtual experience with a negative label (“not selected by user”), the machine-learning model is trained to minimize the number of instances where a user selects a different virtual experience than the top-ranked virtual experience (i.e., the machine-learning model is trained to minimize the number of inversions). Training the model in this manner enables the model to output ordinal ranks that fit user preferences. The ranked items can then be presented in the user interface in the ranked order, thus improving the user experience, since higher ranked items are also more likely to be selected by the user.

The candidate ranker module 204 may train the machine-learning model using training data that includes groups of two virtual experiences. The virtual experience that is selected by a user is referred to as the positive virtual experience and the virtual experience that is not selected is referred to as the negative virtual experience. In some embodiments, the training data is generated after a user is presented with a user interface in which a first experience and one or more second virtual experiences are presented together in a ranked order.

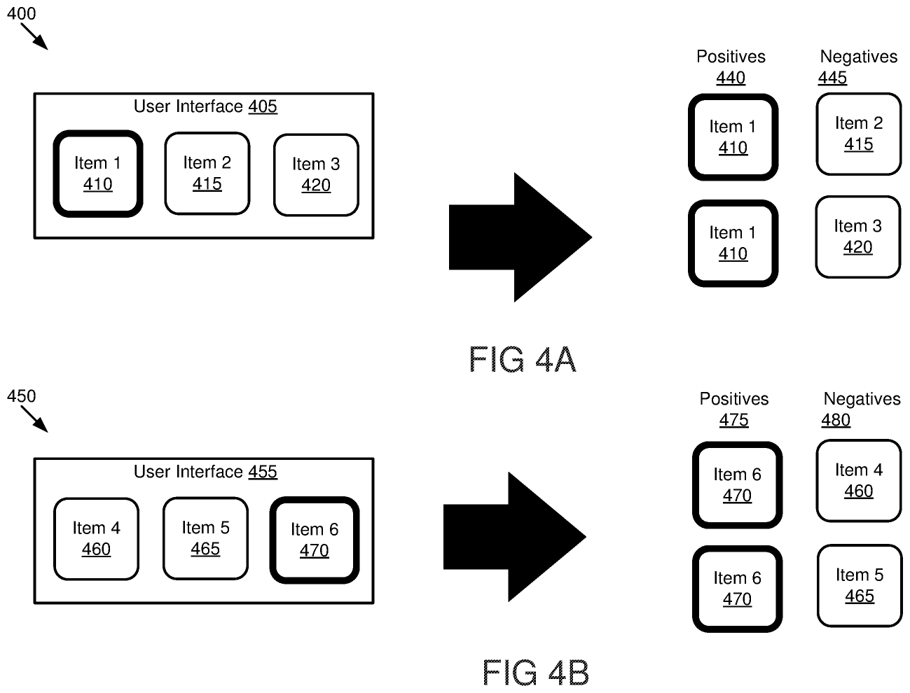

FIG. 4A is an example illustration 400 of training data pair construction with a positive example and a negative example. The user interface 405 presents three items 410, 415, 420 to a user for selection. The user selects item 1 410, which is presented at the first position (leftmost) in the user interface. The training data obtained from the selected items and the unselected items are training pairs of positives 440 and negatives 445 where each positive item 410 is paired with a negative item 415, 420 that was co-impressed with the positive item, resulting in the following pairs: (410, 415) and (410, 420).

FIG. 4B is another example illustration 450 of training data pair construction with a positive example and a negative example. The user interface 455 presents three items 460, 465, 470 to a user for selection. The user selects item 6 470, which is presented at the third position in the user interface. The training data obtained from the selected items and the unselected items are training pairs of positives 475 and negatives 480 where each positive item 470 is paired with a negative item 460, 465 that was co-impressed with the positive item, resulting in the following pairs: (470, 460) and (470, 465).

Although the virtual experiences may be presented in a ranked order (from left to right and top to bottom), the training data indicates whether a virtual experience was selected or not selected, and the pairs indicate which experience (selected) was preferred to over a co-impressed experience (not selected). The positive and negative labels are discussed below with reference to calculating pointwise loss.

The candidate ranker module 204 may train the machine-learning model using training data that includes groups of a first virtual experience that was selected by a user and multiple second virtual experiences that were not selected by the user.

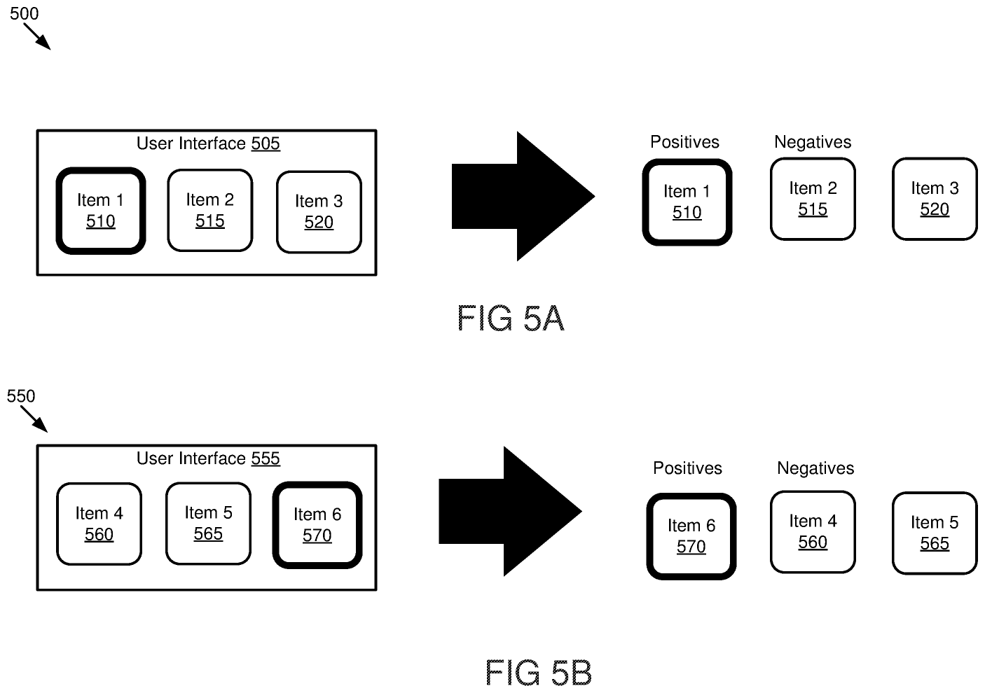

FIG. 5A is an example illustration 500 of training data construction with multiple negative examples. The user interface 505 presents three items 510, 515, and 520 to a user for selection. The user selects item 1 510, which is presented at the first position in the user interface. The training data obtained from the selected items and the unselected items are groups of multiple co-impressed negative items in addition to the positive item.

FIG. 5B is an example illustration 550 of training data construction with multiple negative examples. The user interface 555 presents three items 560, 565, and 570 to a user for selection. The user selects item 6 570, which is presented at the third position in the user interface. The training data generated from the selected items and the unselected items are groups of multiple co-impressed negative items in addition to the positive item. As discussed in greater detail below, the ranked order of the items is used as part of the loss function to capture more context of the ranking.

The candidate ranker module 204 trains the machine-learning model using the training data that includes groups of virtual experiences and a respective user associated with each group. For each group of virtual experiences, the candidate ranker module 204 generates feature embeddings based on the item features of the virtual experiences in the group and the user features of the associated user. Feature embeddings are dense numerical representations of virtual experiences and their relationships, expressed as a vector. The vector space quantifies the similarity between the virtual experiences.

The candidate ranker module 204 calculates, from the machine-learning model, a pointwise loss for each virtual experience in the group based on the feature embeddings. In some embodiments, the pointwise loss is a binary cross-entropy loss based on the following formula:

$$\hat{ℓ} ( y , \hat{y} ) = {\sum }_{j = 0}^{n} {y}_{j} log ( {p}_{j} ) + ( 1 - {y}_{j} ) log ( 1 - {p}_{j} ) \qquad Eq . 1$$

where y is the actual label (i.e., the groundtruth data for the item that was selected), y is the predicted label for the item that was predicted to be selected, and [symbol] is the pointwise loss function of the difference between the predicted item and the selected item. The examples are from n to j where yⱼ is the label for the j example, pⱼ is the model of prediction, and yⱼ log (pⱼ) is the opposite of the label.

The candidate ranker module 204 calculates, from the machine-learning model, a comparator loss for a set that includes the first virtual experience and at least one of the one or more second virtual experiences. In some embodiments, a single example of comparator loss is referred to as pairwise loss.

The pairwise loss may be based on two co-seen elements where a first item is positive (label=1), a second item is negative (label=0), and the pairwise loss is defined based on the following formula:

$$Loss ( p 1 , p 2 , label 1 , label 2 ) = I ( label 1 == 1 ) ⋆ max ( 0 , p 2 - p 1 + D ) + I ( label 2 == 1 ) ⋆ max ( 0 , p 1 - p 2 + D ) \qquad Eq . 2$$

where p1 and p2 correspond to the output probabilities predicted by the machine-learning model for the first item and the second item, respectively, and I {label i} is an indicator function for element/being positive.

Alternatively, in some embodiments, the pairwise hinge loss can be written as:

$${\sum }_{i} max ( 0 , \hat{y} \overline{ι} - {\hat{y}}_{i}^{+} + D ) \qquad Eq . 3$$

where D is a margin hyper-parameter that defines a minimum distance between the output of a positive item and a negative item. The margin is in the interval [0, T], where T corresponds to the range of the model's output (usually between 0 and 1). In some embodiments, the margin may be greater, such as a margin of one, two, or three times the standard deviation of the signal.

The pairwise loss reflects a vector distance between the positive item that was selected and the negative item that was not selected. Accordingly, the score of the positive item as output by the model (once trained) is greater than the score of the negative item. As a result, the margin is defined such that the output of the positive item is higher than the output of the negative item by margin D. This is to ensure that the positive items and the negative items are pushed away from each other in feature space during ranking.

In some embodiments, a combination of multiple pairwise losses are defined as a comparator loss. The candidate ranker module 204 determines the comparator loss by summing each pairwise loss between a first item and a second item. So, for example, where three items are shown to a user, the comparator loss is a sum of (a) the pointwise loss between a first positive item and a second negative item and (b) the pointwise loss between the first positive item and a third negative item. In some embodiments, the sum may be a vector sum, a weighted vector sum, etc. For instance, if two negative items, i.e., A and B were impressed before the positive it, i.e., C, the comparator loss includes two pairwise loss terms. The first pairwise loss is calculated between A and C. The second pairwise loss is calculated between B and C.

The candidate ranker module 204 adjusts one or more parameters of the machine-learning model based on the pointwise loss and the comparator loss. The parameters may include weights associated with the machine-learning model, hyperparameters, etc. In some embodiments, the candidate ranker module 204 adjusts the parameters by performing backpropagation using a loss value that is a linear weighted combination of the pointwise loss and the comparator loss.

In some embodiments, the pointwise loss and the comparator loss are used separately to train the machine-learning model. If only the pointwise loss was used to train the machine-learning model, the co-impression information and the ranked position information would be missing from the training data. If only the comparator loss was used to train the machine-learning model, the machine-learning model might not be stable. In addition, if the comparator loss was used during serving time, different pairs of candidate items would be compared, resulting in a O (N log (N)) ranking problem being turned into a combinatorial problem, which can significantly increase the serving latency. The pointwise loss and the comparator loss may be linearly combined with a weight using the following equation:

$$Pointwise\_loss + weight ⋆ comparator\_loss \qquad Eq . 4$$

The candidate ranker module 204 obtains a trained machine-learning model by iteratively performing the generating, calculating the pointwise loss, calculating the comparator loss, and adjusting the one or more parameters until a stopping criterion is met. The stopping criterion may include a computational budget for training being exhausted and/or a change in parameter values of at least one of the one or more parameters between successive iterations falling below a threshold. The candidate ranker module 204 obtains a trained machine-learning model by iteratively performing the generating, calculating the pointwise loss, calculating the comparator loss, and adjusting the one or more parameters until a stopping criterion is met. The stopping criterion may include a computational budget for training being exhausted and/or a change in loss values between successive iterations falling below a threshold (indicating that the incremental improvement is lower than the threshold) or a change in parameter values of at least one of the one or more parameters between successive iterations falling below a threshold (e.g., indicating that the model is stable).

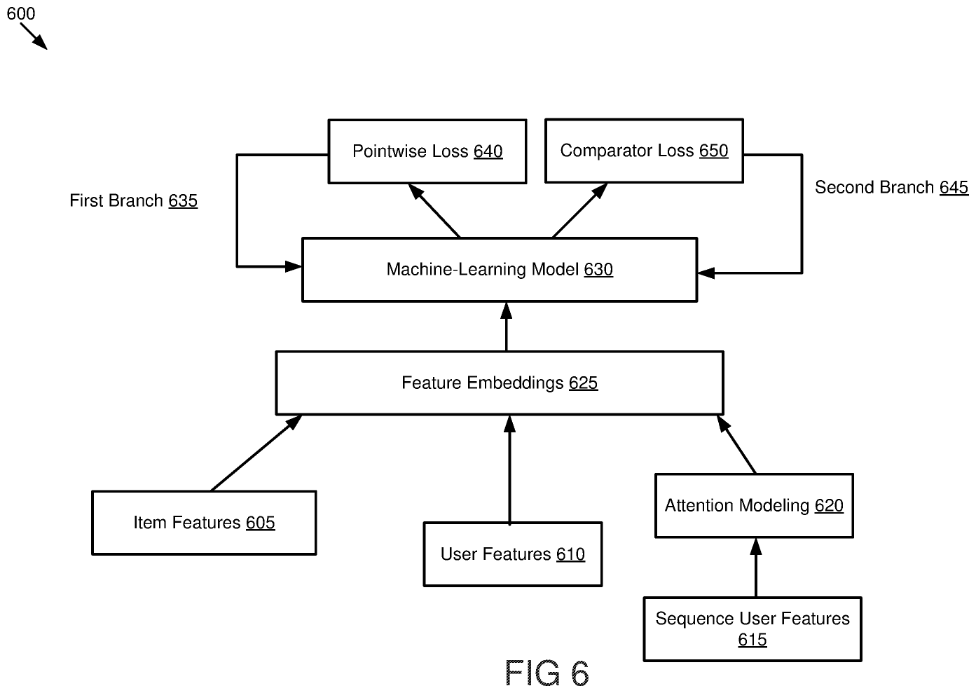

FIG. 6 is a block diagram 600 of an example architecture of the candidate ranker module. In some embodiments, item features 605, user features 610, and sequence user features 615 are used to generate feature embeddings 625. In some embodiments, feature embeddings may be generated by any suitably trained machine learning model which is independent of machine-learning model 630. Separation of the generation of feature embeddings from candidate generation and ranking may provide a technical benefit by enabling pre-trained models to be used to generate feature embeddings that can be provided as input to machine-learning model 630. For example, in many contexts, machine-learning models generate feature embeddings that may be developed for various purposes and can be reused for candidate generation and ranking using the architecture illustrated in FIG. 6.

In some implementations, machine-learning model 630 may generate the feature embeddings 625 (based on features 605-615). Item features 605 describe (are indicative of) attributes of a virtual experience, user features 610 describe (are indicative of) attributes of a user, and sequence user features 615 describe (are based on) a history of user actions, such as a user purchase history, a user viewing history, a user playing history, etc. The sequence user features 615 may be provided as input to an attention modeling system 620 that uses the sequence user features 615 to capture both negative items and their metadata.

The feature embeddings 615 are provided as input to the machine-learning model 630, which outputs a ranked order of items. In some implementations, machine-learning model 630 may separately implement one or more candidate generators (310) and a candidate ranker (315), also referred to as reranker model. In these implementations, items identified by the candidate generators may be provided as input to the candidate ranker which outputs a ranked set of items that be used for display in a user interface. The machine-learning model 630 may be a deep neural network, a convolutional neural network, recurrent neural networks, a perceptron, etc. In some implementations, the candidate generation and ranking functionality may be combined into a single model that is trained using the pointwise loss 640 and comparator loss 650, as described herein.

The machine-learning model 630 outputs the ranked order of items, which may be analyzed with two different types of loss functions. The process of comparing loss functions may be divided into a first branch 635 and a second branch 645. The first branch 635 represents the positive items that were selected where a pointwise loss 640 is calculated and compared to the comparator loss 650.

The second branch 645 represents a second bifurcation where the positive items are compared to the negative items to calculate a comparator loss 650. Backpropagation is performed by performing a linear weighted combination of the pointwise loss 640 and the comparator loss 650. The machine-learning model 630 uses both the first branch 635 and the second branch 645. In some implementations, using two different loss functions is technically advantageous as it makes convergence of the machine-learning model 630 easier (faster, within fewer training epochs, and at low computational cost) and the machine-learning model 630 becomes more stable. The pointwise loss 640 and the comparator loss 650 are used to modify the parameters of the machine-learning model 630 until training is complete.

In some embodiments, both the first branch 635 and the second branch 645 are used during training of the machine-learning model. Once training of the machine-learning model is complete, a similar architecture is used but the second branch 645 is not used during inference time-prediction because the latency requirement is too high. During serving time, the trained machine-learning model is used to predict scores for items based on the pointwise loss 640 and not the comparator loss 650. For example, scores from the first branch 635 are used to rank candidate items where the trained machine-learning model has captured the pairwise relationship based on the combined loss. As a result, calculating scores during serving time based on the first branch 635 is more accurate than if the scores were generated from a machine-learning model that was trained on pointwise loss and not comparator loss.

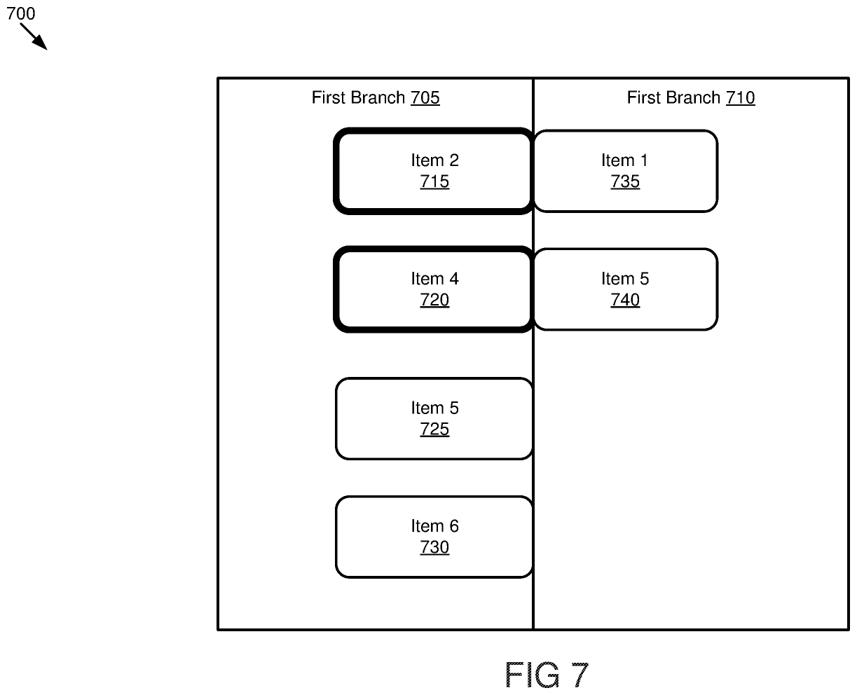

FIG. 7 is a block diagram 700 that illustrates how the first branch 705 and the second branch 710 in the example architecture of FIG. 6 compare positive items and negative items for loss functions. The first branch 705 includes item 2 715, item 4 720, item 5 725, and item 6 730. The second branch 710 includes item 1 735 and item 5 740. The first branch 705 determines a pointwise loss by applying a 1 to the positive items 715, 720 and a 0 to the negative items 725, 730. The second branch 710 determines a comparator loss by comparing positive item 2 715 that was co-impressed with negative item 1 735 and positive item 4 720 that was co-impressed with negative item 5 740. The comparator loss includes a consideration of a ranking of each of the items that are selected or not selected.

The user interface module 206 generates a user interface for users associated with user devices. The user interface may be used to display a user interface that includes recommended virtual experiences for a user. The user interface may also include options for selecting one or more of the recommended virtual experiences. In some embodiments, the user interface includes options for modifying options associated with the metaverse, such as options for configuring a user profile to include user preferences.

In some embodiments, with user consent, the user's selection and nonselection of virtual experiences is used as training data along with item features that describe the virtual experiences, user features that describe the user, and the ranked order of the virtual experiences. In some embodiments, a user selects a virtual experience presented in a user interface by using a mouse, providing touch input, using audio commands, etc. In some embodiments, the user interface is an audio user interface that orally provides a user with options for items, for example, by reciting a list of options and receiving an audio command of a selection of one of the items.

In some embodiments, once the candidate generator module 202 trains a first machine-learning model, the candidate generator module 202 provides candidate user features for a candidate user as input to the first machine-learning model. The first machine-learning model outputs candidate virtual experiences. In some embodiments, the candidate virtual experiences, candidate user features, and candidate item features corresponding to the candidate virtual experiences are provided as input to a second machine-learning model trained by the candidate ranker module 204. The second machine-learning model outputs a rank for each of the candidate virtual experiences. The user interface module 206 generates graphical data for displaying a user interface that includes the candidate virtual experiences in order of rank. The user interface is provided to the user.

In some embodiments, before a user participates in the metaverse, the user interface module 206 generates a user interface that includes information about how the user's information is collected, stored, and analyzed. For example, the user interface requires the user to provide permission to use any information associated with the user. The user is informed that the user information may be deleted by the user, and the user may have the option to choose what types of information are provided for different uses. The use of the information is in accordance with applicable regulations and the data is stored securely. Data collection is not performed in certain locations and for certain user categories (e.g., based on age or other demographics), the data collection is temporary (i.e., the data is discarded after a period of time), and the data is not shared with third parties. Some of the data may be anonymized, aggregated across users, or otherwise modified so that specific user identity cannot be determined.

### Example Methods

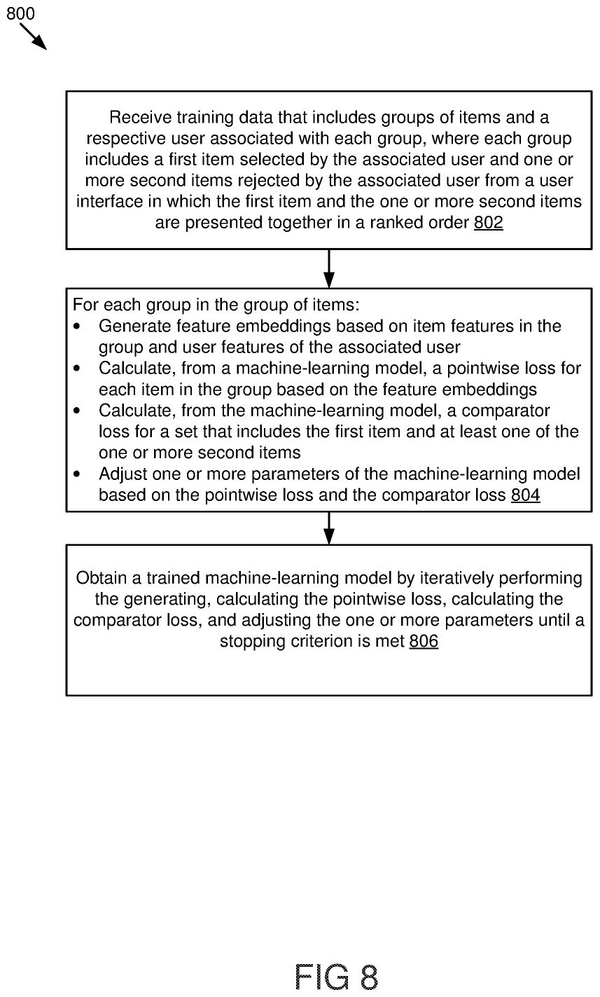

FIG. 8 is a flow diagram of an example method 800 to train a machine-learning model to rank items (e.g., virtual experiences) for presentation in a user interface. In some embodiments, the method 800 is performed by the metaverse application 104 stored on the server 101 in FIG. 1.

The method 800 may begin at block 802. At block 802, training data is received that includes groups of items and a respective user associated with each group. Each group includes a first item selected by the associated user and one or more second items rejected by the associated user from a user interface in which the first item and the one or more second items are presented together in a ranked order. Block 802 may be followed by block 804.

At block 804, for each group in the group of items: feature embeddings are generated based on item features in the group and user features of the associated user; a pointwise loss for each item in the group is calculated from a machine-learning model based on the feature embeddings; a comparator loss is calculated from the machine-learning model for a set that includes the first item and at least one of the one or more second items; and one or more parameters of the machine-learning model are adjusted based on pointwise loss and the comparator loss. Block 804 may be followed by block 806.

At block 806, a trained machine-learning model is obtained by iteratively performing the generating, calculating the pointwise loss, calculating the comparator loss, and adjusting the one or more parameters until a stopping criterion is met.

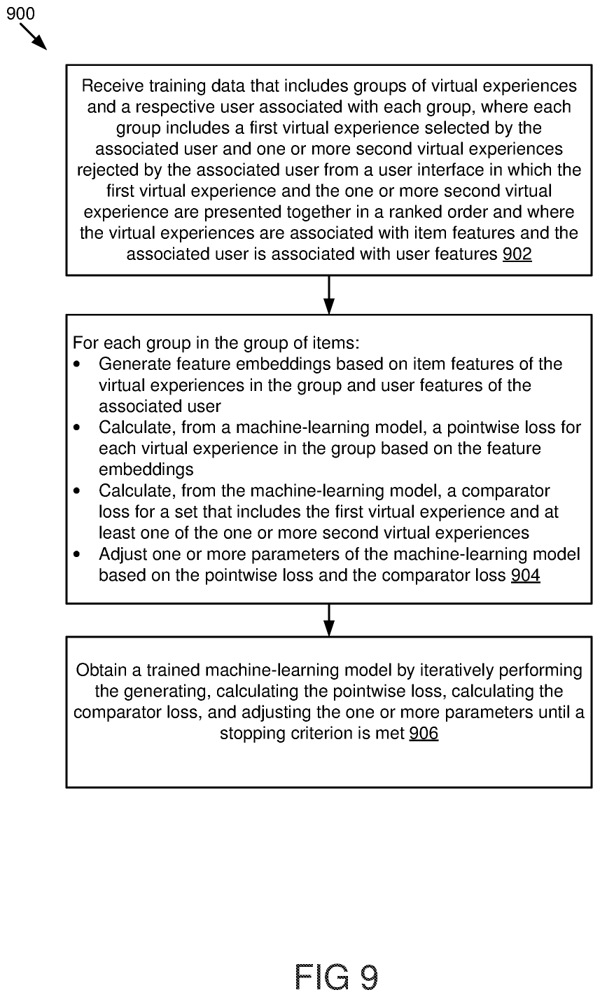

FIG. 9 is a flow diagram of an example method 900 to train a machine-learning model to recommend virtual experiences. In some embodiments, the method 900 is performed by the metaverse application 104 stored on the server 101 in FIG. 1.

The method 900 may begin at block 902. At block 902, training data is received that includes groups of virtual experiences and a respective user associated with each group. Each group includes a first virtual experience selected by the associated user and one or more second virtual experiences rejected by the associated user from a user interface in which the first virtual experience and the one or more second virtual experiences are presented together in a ranked order. The virtual experiences are associated with item features and the associated user is associated with user features. Block 902 may be followed by block 904.

At block 904, the following steps occur for each group in the group of virtual experiences. Feature embeddings are generated based on item features in the group and user features of the associated user. A pointwise loss for each item in the group is calculated from a machine-learning model based on the feature embeddings. The pointwise loss for the virtual experience may be based on an output probability predicted by the machine-learning model.

A comparator loss is calculated from the machine-learning model for a set that includes the first virtual experience and at least one of the one or more second virtual experiences. The comparator loss for each group may be calculated as a sum of a respective pairwise loss for each comparison of the first virtual experience and a particular one of the one or more second virtual experiences. The respective pairwise loss may include a sum of a difference in output probabilities associated with the first virtual experience and the particular one of the one or more second virtual experiences. The respective pairwise loss may further include a hyperparameter that defines a minimum distance.

One or more parameters of the machine-learning model are adjusted based on pointwise loss and the comparator loss. Adjusting the one or more parameters may include performing backpropagation using a loss value that is a linear weighted combination of the pointwise loss and the comparator loss. Block 904 may be followed by block 906.

At block 906, a trained machine-learning model is obtained by iteratively performing the generating, calculating the pointwise loss, calculating the comparator loss, and adjusting the one or more parameters until a stopping criterion is met. The stopping criterion may include a computational budget for training being exhausted and/or a change in parameter values of at least one of the one or more parameters between successive iterations falling below a threshold.

In some embodiments, the method further includes obtaining a sequence of user features, where the sequence is based on user activity on a virtual experience platform that hosts the virtual experiences and performing attention modeling based on the sequence of user features. The sequence of user features may include an order in which the user views different virtual experiences. The feature embeddings may be based on the attention modeling. The user activity may include selecting particular virtual experiences.

In some embodiments, the method further includes receiving candidate user features for a candidate user and candidate item features for a plurality of candidate virtual experiences. The trained machine-learning model may output a rank for each of the candidate virtual experiences. The candidate virtual experiences may be displayed in a second user interface in order of the rank.

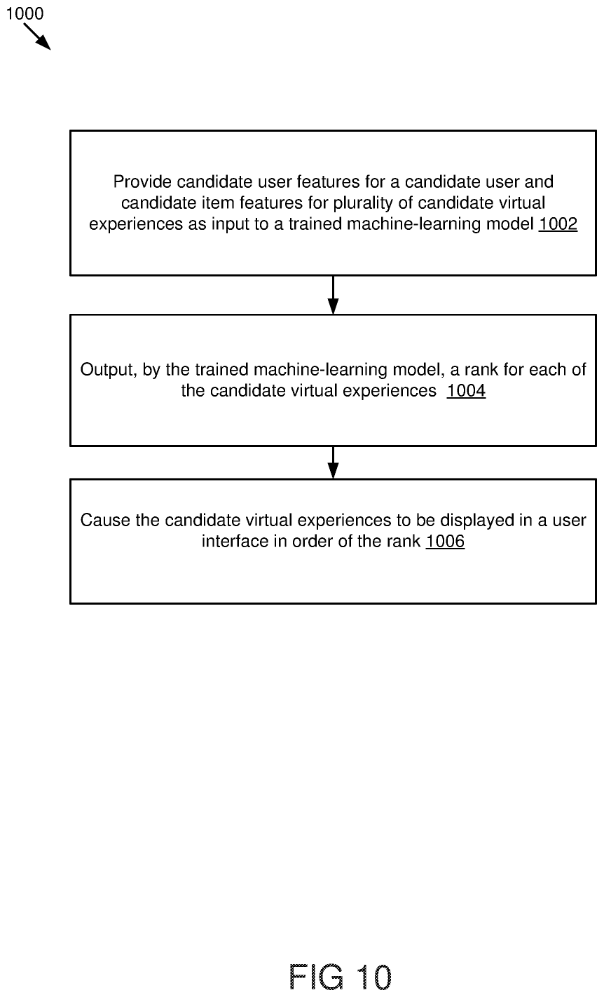

FIG. 10 is a flow diagram of an example method 1000 to provide candidate virtual experiences to a user. In some embodiments, the method 1000 is performed by the metaverse application 104 stored on the server 101 in FIG. 1.

The method 1000 may begin at block 1002. At block 1002, candidate user features for a candidate user and candidate item features for a plurality of candidate virtual experiences are provided as input to a trained machine-learning model. Block 1002 may be followed by block 1004.

At block 1004, the trained machine-learning model outputs a rank for each of the candidate virtual experiences. The rank may include a score for each of the candidate virtual experiences. Block 1004 may be followed by block 1006.

At block 1006, the candidate virtual experiences are displayed in a user interface in order of the rank.

The methods, blocks, and/or operations described herein can be performed in a different order than shown or described, and/or performed simultaneously (partially or completely) with other blocks or operations, where appropriate. Some blocks or operations can be performed for one portion of data and later performed again, e.g., for another portion of data. Not all of the described blocks and operations need be performed in various implementations. In some implementations, blocks and operations can be performed multiple times, in a different order, and/or at different times in the methods.

Various embodiments described herein include obtaining data from various sensors in a physical environment, analyzing such data, generating recommendations, and providing user interfaces. Data collection is performed only with specific user permission and in compliance with applicable regulations. The data are stored in compliance with applicable regulations, including anonymizing or otherwise modifying data to protect user privacy. Users are provided clear information about data collection, storage, and use, and are provided options to select the types of data that may be collected, stored, and utilized. Further, users control the devices where the data may be stored (e.g., user device only; client+server device; etc.) and where the data analysis is performed (e.g., user device only; client+server device; etc.). Data are utilized for the specific purposes as described herein. No data is shared with third parties without express user permission.

In the above description, for purposes of explanation, numerous specific details are set forth in order to provide a thorough understanding of the specification. It will be apparent, however, to one skilled in the art that the disclosure can be practiced without these specific details. In some instances, structures and devices are shown in block diagram form in order to avoid obscuring the description. For example, the embodiments can be described above primarily with reference to user interfaces and particular hardware. However, the embodiments can apply to any type of computing device that can receive data and commands, and any peripheral devices providing services.

Reference in the specification to “some embodiments” or “some instances” means that a particular feature, structure, or characteristic described in connection with the embodiments or instances can be included in at least one implementation of the description. The appearances of the phrase “in some embodiments” in various places in the specification are not necessarily all referring to the same embodiments.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic data capable of being stored, transferred, combined, compared, and otherwise manipulated. It has proven convenient at times, principally for reasons of common usage, to refer to these data as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms including “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The embodiments of the specification can also relate to a processor for performing one or more steps of the methods described above. The processor may be a special-purpose processor selectively activated or reconfigured by a computer program stored in the computer. Such a computer program may be stored in a non-transitory computer-readable storage medium, including, but not limited to, any type of disk including optical disks, ROMs, CD-ROMs, magnetic disks, RAMS, EPROMs, EEPROMs, magnetic or optical cards, flash memories including USB keys with non-volatile memory, or any type of media suitable for storing electronic instructions, each coupled to a computer system bus.

The specification can take the form of some entirely hardware embodiments, some entirely software embodiments or some embodiments containing both hardware and software elements. In some embodiments, the specification is implemented in software, which includes, but is not limited to, firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A data processing system suitable for storing or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

What is claimed is:

1. A computer-implemented method comprising:
receiving training data that includes groups of virtual experiences and a respective user associated with each group, wherein each group includes a first virtual experience selected by the associated user and one or more second virtual experiences rejected by the associated user from a user interface in which the first virtual experience and the one or more second virtual experiences are presented together in a ranked order and wherein the virtual experiences are associated with item features and the associated user is associated with user features;
for each group in the groups of virtual experiences:
generating feature embeddings based on the item features of the virtual experiences in the group and the user features of the associated user;
calculating, from a machine-learning model, a pointwise loss for each virtual experience in the group based on the feature embeddings;
calculating, from the machine-learning model, a comparator loss for a set that includes the first virtual experience and at least one of the one or more second virtual experiences; and
adjusting one or more parameters of the machine-learning model based on the pointwise loss and the comparator loss; and
obtaining a trained machine-learning model by iteratively performing the generating, calculating the pointwise loss, calculating the comparator loss, and adjusting the one or more parameters until a stopping criterion is met.

2. The method of claim 1, wherein adjusting the one or more parameters of the machine-learning model based on the pointwise loss and the comparator loss comprises performing backpropagation using a loss value that is a linear weighted combination of the pointwise loss and the comparator loss.

3. The method of claim 1, wherein the pointwise loss for the virtual experience is based on an output probability predicted by the machine-learning model.

4. The method of claim 1, wherein the comparator loss for each group is a sum of a respective pairwise loss for each comparison of the first virtual experience and a particular one of the one or more second virtual experiences.

5. The method of claim 4, wherein the respective pairwise loss includes a sum of a difference in output probabilities associated with the first virtual experience and the particular one of the one or more second virtual experiences.

6. The method of claim 4, wherein the respective pairwise loss further includes a hyperparameter that defines a minimum distance.

7. The method of claim 1, further comprising:
obtaining a sequence of user features, wherein the sequence is based on user activity on a virtual experience platform that hosts the virtual experiences; and
performing attention modeling based on the sequence of user features, wherein the feature embeddings are based on the attention modeling.

8. The method of claim 7, wherein the user activity includes selecting particular virtual experiences.

9. The method of claim 1, wherein the stopping criterion includes one or more of: a computational budget for training being exhausted or a change in parameter values of at least one of the one or more parameters between successive iterations falling below a threshold.

10. The method of claim 1, further comprising:
receiving candidate user features for a candidate user and candidate item features for a plurality of candidate virtual experiences;
outputting, by the trained machine-learning model, a rank for each of the candidate virtual experiences; and
causing the candidate virtual experiences to be displayed in a second user interface in order of the rank.

11. A non-transitory computer-readable medium with instructions that, when executed by one or more processors, cause the one or more processors to perform operations, the operations comprising:
receiving training data that includes groups of virtual experiences and a respective user associated with each group, wherein each group includes a first virtual experience selected by the associated user and one or more second virtual experiences rejected by the associated user from a user interface in which the first virtual experience and the one or more second virtual experiences are presented together in a ranked order and wherein the virtual experiences are associated with item features and the associated user is associated with user features;
for each group in the groups of virtual experiences:
generating feature embeddings based on the item features of the virtual experiences in the group and the user features of the associated user;
calculating, from a machine-learning model, a pointwise loss for each virtual experience in the group based on the feature embeddings;
calculating, from the machine-learning model, a comparator loss for a set that includes the first virtual experience and at least one of the one or more second virtual experiences; and
adjusting one or more parameters of the machine-learning model based on the pointwise loss and the comparator loss; and
obtaining a trained machine-learning model by iteratively performing the generating, calculating the pointwise loss, calculating the comparator loss, and adjusting the one or more parameters until a stopping criterion is met.

12. The computer-readable medium of claim 11, wherein adjusting the one or more parameters of the machine-learning model based on the pointwise loss and the comparator loss comprises performing backpropagation using a loss value that is a linear weighted combination of the pointwise loss and the comparator loss.

13. The computer-readable medium of claim 11, wherein the pointwise loss for the virtual experience is based on an output probability predicted by the machine-learning model.

14. The computer-readable medium of claim 11, wherein the comparator loss for each group is a sum of a respective pairwise loss for each comparison of the first virtual experience and a particular one of the one or more second virtual experiences.

15. The computer-readable medium of claim 14, wherein the respective pairwise loss includes a sum of a difference in output probabilities associated with the first virtual experience and the particular one of the one or more second virtual experiences.

16. A system comprising:
one or more processors; and
a memory coupled to the one or more processors, with instructions stored thereon that, when executed by the one or more processors, cause the one or more processors to perform operations comprising:
receiving training data that includes groups of virtual experiences and a respective user associated with each group, wherein each group includes a first virtual experience selected by the associated user and one or more second virtual experiences rejected by the associated user from a user interface in which the first virtual experience and the one or more second virtual experiences are presented together in a ranked order and wherein the virtual experiences are associated with item features and the associated user is associated with user features;
for each group in the groups of virtual experiences:
generating feature embeddings based on the item features of the virtual experiences in the group and the user features of the associated user;
calculating, from a machine-learning model, a pointwise loss for each virtual experience in the group based on the feature embeddings;
calculating, from the machine-learning model, a comparator loss for a set that includes the first virtual experience and at least one of the one or more second virtual experiences; and
adjusting one or more parameters of the machine-learning model based on the pointwise loss and the comparator loss; and
obtaining a trained machine-learning model by iteratively performing the generating, calculating the pointwise loss, calculating the comparator loss, and adjusting the one or more parameters until a stopping criterion is met.

17. The system of claim 16, wherein adjusting the one or more parameters of the machine-learning model based on the pointwise loss and the comparator loss comprises performing backpropagation using a loss value that is a linear weighted combination of the pointwise loss and the comparator loss.

18. The system of claim 16, wherein the pointwise loss for the virtual experience is based on an output probability predicted by the machine-learning model.

19. The system of claim 16, wherein the comparator loss for each group is a sum of a respective pairwise loss for each comparison of the first virtual experience and a particular one of the one or more second virtual experiences.

20. The system of claim 19, wherein the respective pairwise loss includes a sum of a difference in output probabilities associated with the first virtual experience and the particular one of the one or more second virtual experiences.
